(19) United States
(12) Patent Application Publication
(10) Pub. No.: US 2009/0087744 A1
(43) Pub. Date: Apr. 2, 2009

(54) METHOD OF MAKING CATHODE COMPOSITIONS

(75) Inventor: Junwei JIANG, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/234,735

(22) Filed: Sep. 22, 2008

Related U.S. Application Data
(60) Provisional application No. 60/975,995, filed on Sep. 28, 2007.

(51) Int. Cl. H01M 4/52; H01B 1/02

(52) U.S. Cl. 429/218.1; 252/521.2

(57) ABSTRACT

Provided is a method for preparing compositions useful as cathodes in lithium-ion electrochemical cells. The method includes blending a transition metal oxide or hydroxide with a mixed transition metal oxide, adding lithium carbonate, lithium hydroxide, or a combination to form a mixture and then sintering the mixture.

### RELATED APPLICATIONS

This application claims priority to U. S. Provisional Application Ser. No. 60/975,995, filed Sep. 28, 2007, which is herein incorporated by reference in its entirety.

### FIELD

This disclosure relates to methods for preparing compositions useful as cathodes in lithium-ion electrochemical cells.

### BACKGROUND

Lithium-ion batteries typically include an anode, an electrolyte, and a cathode that contains lithium in the form of a lithium-transition metal oxide. Examples of lithium transition metal oxides that have been used as cathode compositions include lithium cobalt dioxide, lithium nickel dioxide, and lithium manganese dioxide. None of these compositions, however, exhibits an optimal combination of high initial capacity, high thermal stability, and good capacity retention after repeated charge-discharge cycling. Recently lithium transition metal mixed oxides such as lithium manganese, nickel and cobalt oxides have been used as cathode compositions for lithium-ion electrochemical cells.

### SUMMARY

There is a need for cathode compositions and methods of producing compositions that have higher energy density and improved cycling performance.

In one aspect, provided is a method of making cathode compositions comprising: blending a cobalt oxide with a mixed metal hydroxide having the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal except Mn, Co, or Ni to form a blend, adding a lithium salt such as lithium carbonate or lithium hydroxide, or a combination thereof to the blend to form a mixture, and sintering the mixture, wherein the sintering is performed after the mixture is blended.

In another aspect, provided is a method of making cathode compositions comprising: blending a nickel oxide with a mixed metal hydroxide having the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal except Mn, Co, or Ni to form a blend, adding a lithium salt such as lithium carbonate or lithium hydroxide or a combination thereof to the blend to form a mixture, and sintering the mixture, wherein the sintering is performed after the mixture is blended.

In this application:

the articles “a”, “an”, and “the” are used interchangeably with “at least one” to mean one or more of the elements being described;

the term “metal” refers to both metals and to metalloids such as carbon, silicon and germanium, whether in an elemental or ionic state;

the terms “lithiate” and “lithiation” refer to a process for adding lithium to a cathode composition;

the terms “delithiate” and “delithiation” refer to a process for removing lithium from a cathode composition;

the terms “powders” or “powdered compositions” refer to particles that can have an average maximum length in one dimension that is no greater than about 100 μm.

the terms “charge” and “charging” refer to a process for providing electrochemical energy to a cell;

the terms “discharge” and “discharging” refer to a process for removing electrochemical energy from a cell, e.g., when using the cell to perform desired work;

the phrase “positive electrode” refers to an electrode (often called a cathode) where electrochemical reduction and lithiation occurs during a discharging process; and

the phrase “negative electrode” refers to an electrode (often called an anode) where electrochemical oxidation and delithiation occurs during a discharging process.

The above-described cathode compositions, and lithium-ion batteries incorporating these compositions, exhibit one or more advantages such as high initial capacities, high average voltages, and good capacity retention after repeated charge-discharge cycling. In addition, the cathode compositions do not evolve substantial amounts of heat during elevated temperature use, thereby improving battery safety. In some embodiments, the disclosed compositions exhibit several, or even all, of these advantages.

The details of one or more embodiments are set forth in the accompanying drawings and description below. Other features, objects, and advantages will be apparent from the description and drawings, and from the claims.

### BRIEF DESCRIPTION OF THE DRAWINGS

FIG. 1 is a graph of voltage (V) vs. specific capacity (mAh/g) for two electrochemical cells—one that has a cathode that includes the sintering mixture of Example 1 and the other that includes known material.

FIG. 2 is a graph of the X-ray diffraction pattern of the cathodes in FIG. 1.

FIG. 3 is a graph of the self-heating rate vs. temperature of the cathodes with the known material in FIG. 1 (after being charged to 4.4 V vs. Li) and the cathode composition with the known material in FIG. 1 reacting with 1M LiPF₆ EC/DEC (1:2 by volume).

FIG. 4 is a comparison of the specific capacity (mAh/g) vs. number of charge/discharge cycles for the two electrochemical cells used in FIG. 1.

FIG. 5 is a dQ/dV curve vs. voltage for the two electrochemical cells used in FIG. 1.

### DETAILED DESCRIPTION

All numbers are herein assumed to be modified by the term “about”. The recitation of numerical ranges by endpoints includes all numbers subsumed within that range (e.g., 1 to 5 includes 1, 1.5, 2, 2.75, 3, 3.80, 4, and 5).

Provided is a method of making cathode compositions that include mixed metal oxides of cobalt, nickel and manganese. These cathode compositions exhibit improved electrochemical performance when incorporated into a lithium-ion electrochemical cell. The improved performance includes one or more of higher energy density, improved cycling performance (less capacity fade) upon repeated cycling, and improved safety.

In a first embodiment provided is a method of making cathode compositions comprising: blending a cobalt oxide with a mixed metal hydroxide having the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal except Mn, Co, or Ni to form a blend, adding lithium a lithium salt to the blend to form a mixture, and then sintering the mixture, wherein sintering is performed after the mixture is blended. Exemplary cobalt oxides that are useful in this method include LiCoO₂, Co₃O₄ and Co₂O₃.

Mixed metal oxides that are useful in this embodiment of the method include mixed metal hydroxides of cobalt, nickel, and manganese that have the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal Mn, Co, or Ni to form a blend. The mixed transition metal hydroxides can be prepared by using a co-precipitation process such as that described in, for example, U.S. Pat. Appl. No. 2004/0179993 A1 (Dahn et al.). The mixed transition metal oxides can be obtained from the hydroxides by sintering. Other mixed transition metal oxides comprising cobalt, nickel, and manganese that can be useful in this invention are disclosed in U.S. Pat. No. 5,900,385 (Dahn et al.), U.S. Pat. No. 6,660,432 B2 (Paulsen et al.), U.S. Pat. No. 6,964,828 B2 (Lu et al.), U.S. Pat. No. 7,211,237 B2 (Eberman et al.), U.S. Pat. Publ. No. 2003/0108793 A1 (Dahn et al.) and U.S. Provisional Appl. Ser. No. 60/916,472 (Jiang). In one embodiment of the invention, the mixed transition metal oxide can be Co_{1/3}Mn_{1/3}Ni_{1/3}O₂ (where x, y, and z are substantially equal and/or a is essentially zero in the formula above). By essentially zero it is meant that there is no substantial amount of another metal M in the composition. There may be, however, trace amounts of impurity metals in the composition. The mixed transition metal oxide of this embodiment can be made by the processes referenced above in this paragraph or it is available from Pacific Lithium Inc, Auckland, New Zealand. Other mixed transition metal oxides can include oxides of cobalt, nickel, manganese, and another metal. Another metal can be selected from lithium, aluminum, titanium, magnesium, and combinations thereof.

One embodiment of the method of this disclosure provides for blending a cobalt oxide with a mixed metal hydroxide or mixed metal oxide as described above. The amount of a cobalt oxide that can be blended with the mixed metal hydroxide or mixed metal oxide can be any amount. For example, in some embodiments, the molar amount of cobalt in the cobalt oxide can be from about 20 mol % (mole percent) to about 80 mol %, from about 30 mol % to about 70 mol %, from about 40 mol % to about 60 mol %, or about 50 mol % of the amount of combined molar amount of cobalt in the mixed metal hydroxide and mixed metal oxide combined. In another embodiment of the method of this disclosure the molar amount of cobalt oxide added to the blend is about the same as the molar amount of cobalt in the mixed metal oxide and the mixed metal hydroxide combined. In yet other embodiments the amount of cobalt oxide added to the blend is greater than the total molar amount of cobalt in the mixed metal oxide and the mixed metal hydroxide combined.

The cobalt oxides and the mixed metal hydroxides or oxides useful in this invention can be in the form of a powder. The cobalt oxide can be blended with the mixed metal hydroxide or oxide. By blending it is meant that two or more powders can be thoroughly mixed together, typically using low shear force. Blending can be accomplished, for example, by shaking the components together in a container, mixing the components with a low shear mixer (such as those available from Brabender, Inc., Dusseldorf, Germany), jet milling, or using any other means to thoroughly blend the powders together without an excess of shear force.

The method of one embodiment of this disclosure also provides for adding a lithium salt to the blend of the cobalt oxide and the mixed metal hydroxide, mixed metal oxide, or a combination thereof. The lithium salt typically is added at room temperature and is mixed with the other components to form a mixture that includes the lithium salt, cobalt oxide and the mixed metal oxide and hydroxide components. Suitable lithium salts are inorganic or organic, such as lithium carbonate, lithium hydroxide, lithium acetate, or a combination of two or more lithium salts.

The method of this disclosure also provides for sintering the mixture. In some embodiments, the sintering can be done in one step by heating the mixture to a temperature above about 700° C. and below about 950° C., above about 750° C. and below about 950° C., or even above about 800° C. and below about 900° C. The heating from room temperature to the sintering temperature can be done by placing the mixture into an oven with the desired sintering temperature, or by ramping up the temperature of the mixture until the mixture reaches the desired sintering temperature. The temperature can be heated to the desired sintering temperature at a rate of about 10° C./min, at a rate of about 8° C./min, at a rate of about 6° C./min, at a rate of 4° C./min, at a rate of 2° C./min, or at an even slower rate. When the sintering temperature is reached, the mixture can then be held at the sintering temperature for a period of time called the “soaking” time. For the disclosed mixtures, the soaking times can be 1 hour or longer, 2 hours or longer, 3 hours or longer, 4 hours or longer, or 5 hours or even longer.

In other embodiments, the mixture can be soaked at one temperature and then the temperature can be raised and the mixture can be further soaked at a different temperature. For example, the mixture can be soaked at a temperature above about 750° C. and below about 950° C. as in the previous embodiment, but after the initial soaking the temperature can be increased to a higher temperature such as above about 1000° C. and then the mixture can be soaked at that temperature. The soaking steps can allow the material time to reach a more stable state.

After sintering, and optionally soaking, the material can be cooled or returned to room temperature over a suitable time, as is known in the art, such as using the opposite of the heating rates described above.

In another embodiment, provided is a method of making cathode compositions comprising: blending a nickel oxide with a mixed metal having the formula, MnₓCo_{y}Ni_{z}Mₐ(OH)₂, a mixed metal oxide having the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal except Mn, Co, or Ni to form a blend, adding a lithium salt to the blend to form a mixture, and then sintering the mixture, wherein the sintering is performed after the mixture is blended. Nickel oxides that are useful in this method include, for example, NiO, LiNiO₂, and Ni(OH)₂. The amount of a nickel oxide that can be blended with the mixed metal hydroxide or mixed metal oxide can be any amount. For example, in some embodiments, the molar amount of nickel in the nickel oxide can be from about 20 mol % (mole percent) to about 80 mol %, from about 30 mol % to about 70 mol %, from about 40 mol % to about 60 mol %, or about 50 mol % of the amount of combined molar amount of nickel in the mixed metal hydroxide and mixed metal oxide combined. In another embodiment of the method of this disclosure the molar amount of nickel oxide added to the blend is about the same as the molar amount of nickel in the mixed metal oxide and the mixed metal hydroxide combined. In yet other embodiments the amount of nickel oxide added to the blend is greater than the total molar amount of nickel in the mixed metal oxide and the mixed metal hydroxide combined. The sintering conditions and limitations are identical for those discussed above for adding cobalt oxide to mixed metal hydroxides and/or oxides.

Cathode compositions that can be made using the methods of the embodiments of this disclosure include, but are not limited to, the compositions that are disclosed in applicants' copending and cofiled application, U.S. Ser. No. 60/975,940. Some embodiments of the invention can be used to produce cathode materials that have an O3 layered structure.

Cathode compositions made according to the methods presented herein can be used to make cathodes for use in electrochemical cells that can be used in a variety of devices, including portable computers, tablet displays, personal digital assistants, mobile telephones, motorized devices (e.g., personal or household appliances and vehicles), instruments, illumination devices (e.g., flashlights) and heating devices. One or more electrochemical cells of this invention can be combined to provide battery pack. Further details regarding the construction and use of rechargeable lithium-ion cells and battery packs will be familiar to those skilled in the art.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references in this disclosure are herein incorporated by reference.

### EXAMPLES

### Electrochemical Cell Preparation

### Preparation of Thin Film Cathodes

Electrodes were prepared as follows: 10% polyvinylidene difluoride (PVDF, Aldrich Chemical Co.) in N-methyl pyrrolidinone (NMP, Aldrich Chemical Co.) solution was prepared by dissolving about 10 g PVDF into 90 g of NMP solution. About 7.33 g SUPER P carbon (MMM Carbon, Belgium), 73.33 g of 10% PVDF in NMP solution, and 200 g NMP solution were mixed in a glass jar. The mixed solution contained about 2.6% of PVDF and SUPER P carbon each in NMP. 5.25 g of the solution was mixed with 2.5 g cathode composition using a MAZERUSTAR mixer machine (available from Kurabo Industries Ltd., Japan) for 3 minutes to form uniform slurry. The slurry was then spread onto a thin aluminum foil on a glass plate using a 0.25 mm (0.010 inches) notch-bar spreader. The coated electrode was then dried in an 80° C. oven for around 30 minutes. The electrode was then put into a 120° C. vacuum oven for 1 hour to evaporate NMP and moisture. The dry electrode contained about 90% cathode material and 5% PVDF and Super P each. The mass loading of the active cathode material was around 8 mg/cm².

### Preparation of Coin Cells

Coin cells were fabricated with the resulting cathode from Examples 1-4 and a Li metal anode in a 2325-size (23 mm diameter and 2.5 mm thickness) coin-cell hardware in a dry room. CELGARD 2400 microporous polypropylene film (available from Hoechst-Celanese) was used as a separator. It was wetted with a 1M solution of LiPF₆ (available from Stella Chemifa Corporation, Japan) dissolved in a 1:2 volume mixture of ethylene carbonate (EC) (Aldrich Chemical Co.) and diethyl carbonate (DEC) (Aldrich Chemical Co.). The coin cells were sealed by crimping.

### Cycling of Coin Cells

The coin cells were initially charged and discharged between 4.4 V and 2.5 V at a current of 15 mA/g in the first cycle. In the second and third cycles, the cells were cycled at a current of 30 mA/g. From the fourth to ninth cycles, the cells were charged at the same current of 15 mA/g and discharged at different currents from 750 mA/g, 300 mA/g, 150 mA/g, 75 mAh/g, 30 mA/g, 15 mA/g, respectively, to test the rate capability of the cathode compositions within. The tenth and later cycles were for the cycling performance test and both charge and discharge currents are 75 mA/g.

### Accelerating Rate Calorimeter (ARC) Exotherm Onset Temperature for Different Cathode Materials.

### Preparation of Pellet Cathodes for ARC.

The method to prepare charged cathode compositions for thermal stability tests by ARC is described in J. Jiang, et al., Electrochemistry Communications, 6, 39-43, (2004). Usually, the mass of a pellet electrode used for the ARC is a few hundred milligrams. A few grams of active electrode material were mixed with 7% by mass, each of Super-P carbon black, PVDF, and excess NMP to make a slurry, following the same procedures described for preparing thin film cathode materials. After drying the electrode slurry at 120° C. overnight, the electrode powder was slightly ground in a mortar and then passed through a 300 μm sieve. A small amount (around 300 mg to 700 mg) of electrode powder was then placed in a stainless steel die to which 13.8 Mpa (2000 psi) was applied to produce an approximately 1 mm thick pellet electrode. A 2325-size coin cell was constructed using the positive electrode pellet and the mesocarbon microbeads (MCMB) (available from E-One Moli/Energy Canada Ltd., Vancouver, BC) pellet sized to balance the capacity of both electrodes. The cells were firstly charged to a desired voltage, such as 4.4 V vs. Li, at a current of 1.0 mA. After reaching 4.4 V, the cells were allowed to relax to 4.1 V vs. Li. Then the cells were recharged to 4.4 V with half of the original current, 0.5 mA. After 4 cycles, the charged cells were transferred to the glove box and dissembled. The delithiated cathode pellets were taken out and rinsed with dimethyl carbonate (DMC) four times to remove the original electrolyte from the surface of charged cathode material. Then the sample was dried in the glove box vacuum antechamber for two hours to remove the residual DMC. Finally the sample was lightly ground again to be used in the ARC tests.

### ARC Exotherm Onset Temperature Measurement.

The stability test by ARC was described in J. Jiang, et al., Electrochemistry Communications, 6, 39-43, (2004). The sample holder was made from 304 stainless steel seamless tubing with a wall thickness of 0.015 mm (0.006 inches) (Microgroup, Medway, Mass.). The outer diameter of the tubing was 6.35 mm (0.250 inches) and the length of pieces cut for the ARC sample holders was 39.1 mm (1.540 inches). The temperature of the ARC was set to 110° C. to start the test. The sample was equilibrated for 15 min., and the self-heating rate was measured over a period of 10 min. If the self-heating rate was less than 0.04° C./ min., the sample temperature was increased by 10° C., at a heating rate of 5° C./min. The sample was equilibrated at this new temperature for 15 min., and the self-heating rate was again measured. The ARC Exotherm Onset Temperature was recorded when the self-heating rate was sustained above 0.04° C./min. The test was stopped when the sample temperature reached 350° C. or the self-heating rate exceeded 20° C./min.

### X-ray Diffraction (XRD) Characterization

X-ray diffraction was to identify the crystalline structure of sintering cathode composition. A Siemens D500 diffractometer equipped with a copper target X-ray tube and a diffracted beam monochromator was used for the diffraction measurements. The emitted X-rays utilized were the Cu K_{α1} (λ=1.54051 Å) and Cu K_{α2} (λ=1.54433 Å). The divergence and anti-scatter slits used were set both at 0.5°, while the receiving slit was set at 0.2 mm. The X-ray tube was powered to 40 kV at 30 mA.

### Materials—Cathode Compositions

Cathode compositions were synthesized from binary mixtures of various amounts of Co₃O₄ and Co_{1/3}Ni_{1/3}Mn_{1/3}(OH)₂ or Ni(OH)₂ and Co_{1/3}Ni_{1/3}Mn_{1/3}(OH)₂ with Li₂CO₂. The resulting cathode materials after synthesis comprise two phases if different composition both of which have a layered O3 (R-3m) structure.

### Example 1

6.953 g of Co₃O₄ (available from OMG Inc., Cleveland, Ohio) and 8.047 g of Li[Co_{1/3}Ni_{1/3}Mn_{1/3}]O₂ (available from Pacific Lithium Inc., New Zealand) were mixed with 6.824 g of Li₂CO₃ (available from FMC, US). The powdered mixture was heated to 750° C. at a rate of 4° C./min and then allowed to remain at that temperature for 4 hours. The powdered mixture then was heated to 1000° C. at 4° C./min and then allowed to remain at that temperature for 4 hours. Then the powder was cooled down to room temperature at 4° C./min. After grinding, the powder then was passed through a 110 μm sieve. EDS analysis of Example 1 was performed and Example 1 was found to have two distinct phases. The first phase was determined by EDS to have a transition metal composition of Co_{0.72}Ni_{0.15}Mn_{0.13} and the second phase had a transition metal composition of Co_{0.55}Ni_{0.23}Mn_{0.22}.

### Example 2

11.637 g of Co₃O₄ and 3.363 g of Li[Co_{1/3}Ni_{1/3}Mn_{1/3}]O₂ were mixed with 6.956 g of Li₂CO₃. The powdered mixture was heated to 750° C. at a rate of 4° C./min and then allowed to remain at that temperature for 4 hours. The powdered mixture then was heated to 1000° C. at 4° C./min and then allowed to remain at that temperature for 4 hours. Then the powder was cooled down to room temperature at 4° C./min. After grinding, the powder then was passed through a 110 μm sieve. The first phase was determined by EDS to have a transition metal composition of Co_{0.90}Ni_{0.05}Mn_{0.05} and the second phase had a transition metal composition of Co_{0.58}Ni_{0.20}Mn_{0.22}. FIG. 6 is an EDS map of the sintered mixture of Example 2.

### Example 3

2.664 g of Co₃O₄ and 12.336 g of Li[Co_{1/3}Ni_{1/3}Mn_{1/3}]O₂ were mixed with 6.704 g of Li₂CO₃. The powdered mixture was heated to 750° C. at a rate of 4° C./min and then allowed to remain at that temperature for 4 hours. The powdered mixture then was heated to 1000° C. at 4° C./min and then allowed to remain at that temperature for 4 hours. Then the powder was cooled down to room temperature at 4° C./min. After grinding, the powder then was passed through a 110 μm sieve. The first phase was determined by EDS to have a transition metal composition of Co_{0.94}Ni_{0.03}Mn_{0.03} and the second phase had a transition metal composition of Co_{0.52}Ni_{0.23}Mn_{0.25}.

### Example 4

7.116 g of Ni(OH)₂ and 7.111 g of Li[Co_{1/3}Ni_{1/3}Mn_{1/3}]O₂ were mixed with 5.975 g of Li₂CO₃. The powdered mixture was heated to 750° C. at a rate of 4° C./min and then allowed to remain at that temperature for 4 hours. The powdered mixture then was heated to 1000° C. at 4° C./min and then allowed to remain at that temperature for 4 hours. Then the powder was cooled down to room temperature at 4° C./min. After grinding, the powder then was passed through a 110 μm sieve. The first phase was determined by EDS to have a transition metal composition of Co_{0.15}Ni_{0.76}Mn_{0.09} and the second phase had a transition metal composition of Co_{0.18}Ni_{0.57}Mn_{0.25}.

### Performance

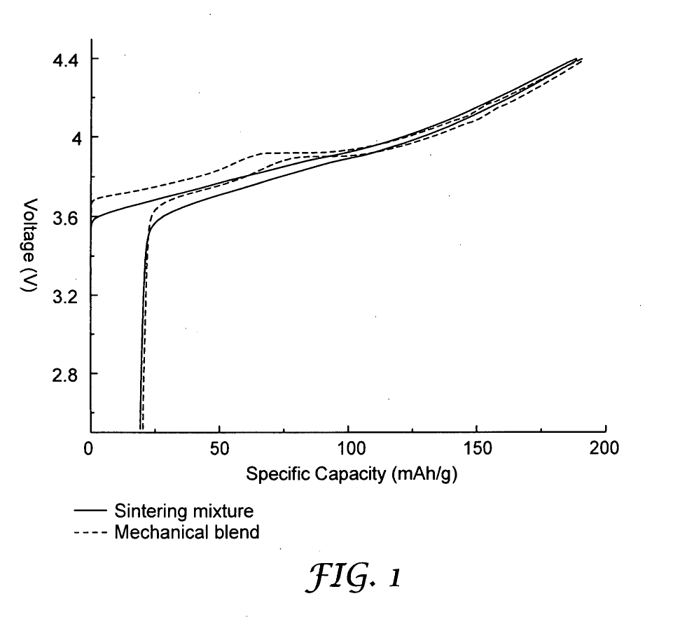

FIG. 1 shows the voltage (V) vs. specific capacity (mAh/g) for an electrochemical cell (coin cell) containing a cathode that is made from the sintering mixture of Example 1 and for another coin cell containing a cathode that is made from a mechanical blend of a 1:1 mass ratio of LiCoO₂ and Li[Co_{1/3}Mn_{1/3}Ni_{1/3}]O₂ with no additional treatment. The electrochemical cells were cycled through one complete cycle by first charging to 4.4 V vs. Li at a current of C/10 (17 mA/g) and then by discharging to 2.5 V vs. Li at the same current. It is clearly shown that the curve for the sintering mixture is smooth and different from that of the mechanical blend.

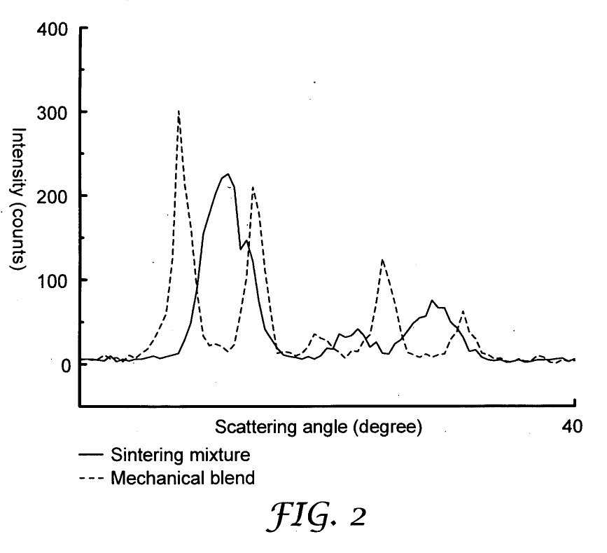

FIG. 2 shows a portion of the X-ray diffraction (XRD) spectrum of the sintering mixture of Example 1 and the 1:1 mechanical blend from the previous paragraph between a scattering angle of 35 and 40 degrees. The crystalline structure of the sintering mixture is very different from that of the mechanical blend and also does not appear to be a combination of the ingredients of the mechanical blend. This XRD scan shows that the sintering material is not the same composition as the mechanical blend.

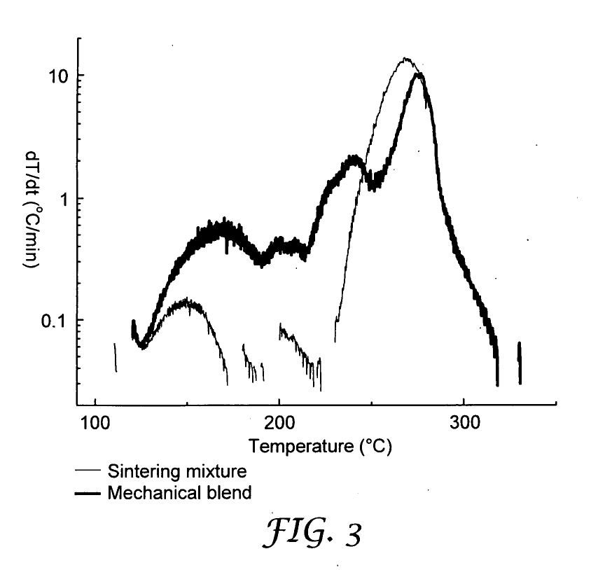

FIG. 3 shows the ARC self-heating rate versus temperature of 100 mg of sintering mixture from Example 1 (after charged to 4.4 V vs. Li) reacting with 30 mg 1 M LiPF₆ EC/DEC compared to 100 mg of the 1:1 mechanical blend described above. The mechanical blend was shown to have an onset temperature of self-heating of about 120° C. The sintering mixture had a much higher onset temperature of self-heating (around 260° C.). This suggests that the sintering mixture of Example 1 had significantly greater thermal stability than a mechanical blend with the same molar ratio (1:1) of metals.

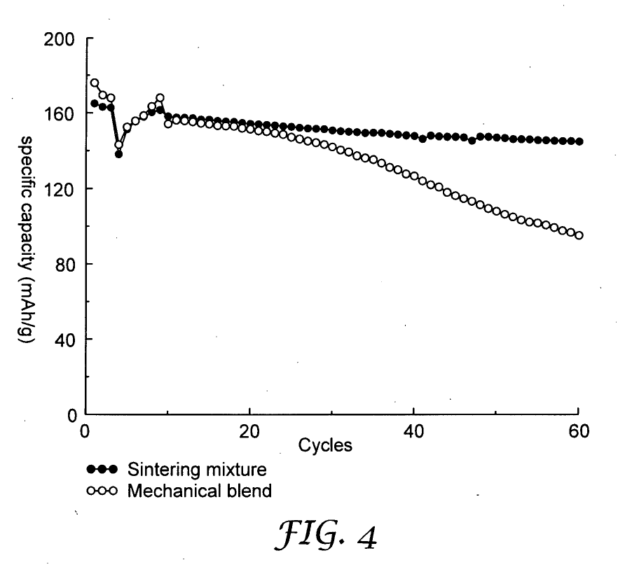

FIG. 4 is a plot of the cycling performance comparison of the sintering mixture from Example 1 and a mechanical blend with the same mass ratio (1:1) of metals from 2.5 to 4.4 V. The sintering mixture clearly showed higher capacity and better capacity retention after 60 cycles at a current of 75 mAh/g than the mechanical blend.

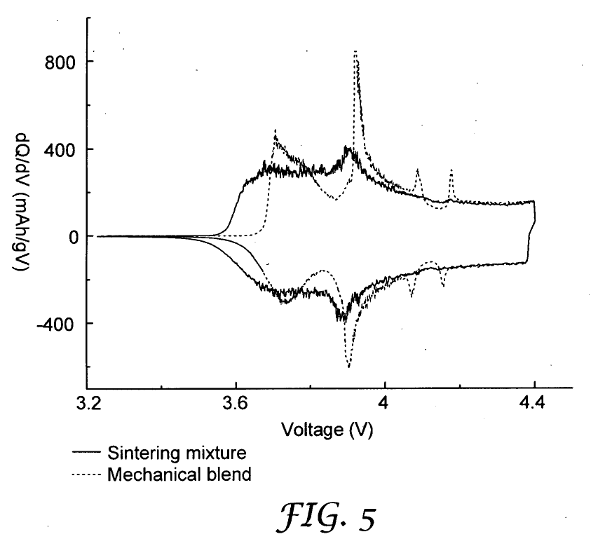

FIG. 5 is a plot of the differential (dQ/dV) in mAh/(gV) vs. voltage for the sintering mixture of Example 1 and a mechanical blend with the same mass ratio (1:1) of metals upon cycling to 4.4 V vs. Li. FIG. 5 shows that the electrochemical behavior of the sintering mixture is very different from that of the mechanical blend indicating the two materials have very different properties.

A number of embodiments have been described. Nevertheless, it will be understood that various modifications may be made without departing from the spirit and scope of the invention. Accordingly, other embodiments are within the scope of the following claims.

What is claimed is:

1. A method of making cathode compositions comprising:
blending a cobalt oxide with a mixed metal hydroxide having the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal except Mn, Co, or Ni to form a blend;
adding a lithium salt to the blend to form a mixture; and
sintering the mixture,
wherein the sintering is performed after the mixture is blended.

2. The method of claim 1 wherein the cobalt oxide comprises lithium cobalt oxide.

3. The method of claim 1 wherein the molar amount of cobalt in the cobalt oxide added to the blend is about the same as the molar amount of cobalt in the mixed metal oxide and the mixed metal hydroxide combined.

4. The method of claim 1 wherein the molar amount of cobalt oxide is from about 0.20 to about 0.80 of the molar amount of cobalt in the mixed metal oxide and the mixed metal hydroxide combined.

5. The method of claim 1 wherein x, y, and z are substantially equal.

6. The method of claim 1 wherein M is selected from Li, Al, Ti, Mg, and combinations thereof.

7. The method of claim 1 wherein sintering comprises heating the mixture to a temperature above about 750° C. and below about 1000° C.

8. The method of claim 7 wherein sintering further comprises subsequently heating the mixture to a temperature above about 1000° C.

9. A method of making cathode compositions comprising:
blending a nickel oxide with a mixed metal hydroxide having the formula, Mnₓ₁Co_{y1}Ni_{z1}Mₐ₁(OH)₂, a mixed metal oxide having the formula Mnₓ₂Co_{y2}Ni_{z2}Mₐ₂O_{q}, or a combination thereof, wherein each x1, x2, y1, y2, z1 and z2>0, a1 and a2≧0, x1+y1+z1+a1=1, x2+y2+z2+a2=1 and q>0, and M is selected from any transition metal except Mn, Co, or Ni to form a blend;
adding a lithium salt to the blend to form a mixture; and
sintering the mixture,
wherein the sintering is performed after the mixture is blended.

10. The method of claim 9 wherein the nickel oxide comprises lithium nickel oxide.

11. The method of claim 9 wherein the molar amount of nickel in the nickel oxide added to the blend is about the same as the molar amount of nickel in the mixed metal oxide and the mixed metal hydroxide combined.

12. The method of claim 9 wherein the molar amount of nickel is from about 0.20 to about 0.80 the molar amount of nickel in the mixed metal oxide and the mixed metal hydroxide combined.

13. The method of claim 9 wherein x, y, and z are substantially equal.

14. The method of claim 9 wherein M is selected from Li, Al, Ti, Mg, and combinations thereof.

15. The method of claim 9 wherein sintering comprises heating the mixture to a temperature above about 750° C. and below about 1000° C.

16. The method of claim 9 wherein sintering further comprises subsequently heating the mixture to a temperature above about 1000° C.

17. An electrochemical cell comprising a cathode that is made from the method of claims 1 or 9.
